(19) United States
(12) Patent Application Publication
(10) Pub. No.: US 2016/0124650 A1
(43) Pub. Date: May 5, 2016

(54) Data Storage Device and Flash Memory Control Method

(71) Applicant: Silicon Motion, Inc., Jhubei City (TW)

(72) Inventor: Yi-Kang Chang, New Taipei City (TW)

(73) Assignee: Silicon Motion, Inc.

(21) Appl. No.: 14/920,301

(22) Filed: Oct. 22, 2015

(30) Foreign Application Priority Data
Nov. 3, 2014 (TW) 103138008

(51) Int. Cl. G06F 3/06

(52) U.S. Cl. CPC G06F 3/064; G06F 3/0604; G06F 3/0679

(57) ABSTRACT

A flash memory control technology with high performance efficiency is provided. A microcontroller is configured to build an ending logical address table in a random access memory to record ending logical addresses of a plurality of old write commands issued from a host. The microcontroller is further configured to compare a starting address of a current write command issued from the host and information in the ending logical address table, to determine whether any of the plurality of old write commands is a former string write command with respect to the current write command that the former string write command and the current write command combined together form sequential data writing. The microcontroller is further configured to overwrite an ending logical address of the current write command onto a column in the ending logical address table recording the ending logical address of the former string write command.

### CROSS REFERENCE TO RELATED APPLICATIONS

This Application claims priority of Taiwan Patent Application No. 103138008, filed on Nov. 03, 2014, the entirety of which is incorporated by reference herein.

### BACKGROUND OF THE INVENTION

1. Field of the Invention

The present invention relates to data storage devices with flash memory and flash memory control methods.

2. Description of the Related Art

Flash memory, a data storage medium, is common in today's data storage devices. A NAND flash is one common type of flash memory.

For example, flash memory is typically used in memory cards, USB flash devices, solid-state drives, and so on. In another application with multi-chip package technology, a NAND flash chip and a controller chip are combined in one package as an embedded multi-media card (e.g. eMMC).

The storage space of a flash memory generally provides a plurality of physical blocks, and each physical block includes a plurality of physical pages. To release storage space for reuse, an erase operation has to be performed on a block-by-block basis, to release space one block at a time. When updating data, the new data is written into a spare space rather than being overwritten onto old data, and the old data has to be invalidated. Thus, the storage space management of flash memory is more complex than other storage mediums. A controller designed especially for flash memory is therefore called for.

### BRIEF SUMMARY OF THE INVENTION

In the disclosure, for a data storage device using a flash memory as the non-volatile storage medium, the write data is written into the flash memory in accordance with the data attribution thereof, different data attributions corresponding to different physical blocks of the flash memory.

A data storage device in accordance with an exemplary embodiment of the disclosure comprises a flash memory and a control unit. The control unit comprises a microcontroller and a random access memory and is coupled between a host and the flash memory. The microcontroller is configured to build an ending logical address table in the random access memory to record ending logical addresses of a plurality of old write commands issued from the host. The microcontroller is configured to compare a starting logical address of a current write command and information recorded in the ending logical address table to determine whether any of the old write commands is a former string write command with respect to the current write command that the former string write command and the current write command combined together form sequential data writing. The microcontroller is configured to overwrite an ending logical address of the current write command onto a column in the ending logical address table recording the ending logical address of the former string write command.

In accordance with another exemplary embodiment of the disclosure, a flash memory control method comprises the following steps: building an ending logical address table in a random access memory to record ending logical addresses of a plurality of old write commands issued from a host; comparing a starting logical address of a current write command and information recorded in the ending logical address table to determine whether any of the old write commands is a former string write command with respect to the current write command that the former string write command and the current write command combined together form sequential data writing; and overwriting an ending logical address of the current write command onto a column in the ending logical address table recording the ending logical address of the former string write command.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a data storage device 100 in accordance with an exemplary embodiment of the disclosure; and

FIG. 2 is a flowchart depicting a write operation of a flash memory in accordance with an exemplary embodiment of the disclosure.

### DETAILED DESCRIPTION OF THE INVENTION

The following description shows exemplary embodiments for carrying out the invention. This description is made for the purpose of illustrating the general principles of the invention and should not be taken in a limiting sense. The scope of the invention is best determined by reference to the appended claims.

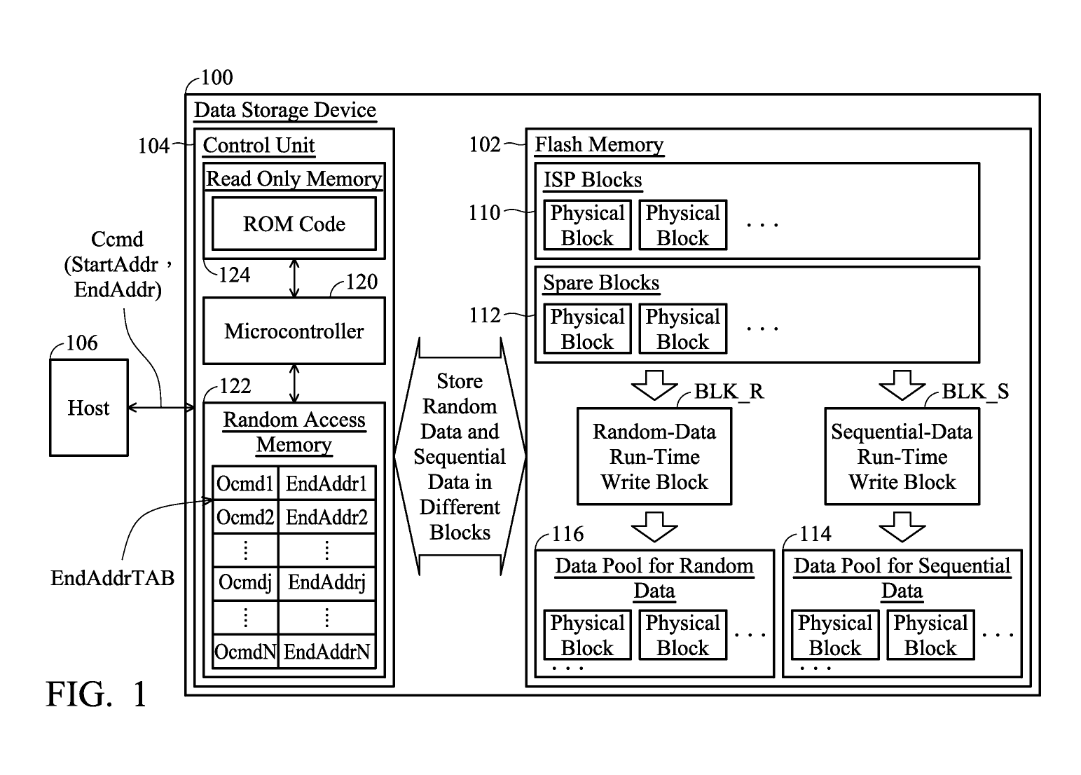

FIG. 1 depicts a data storage device 100 in accordance with an exemplary embodiment of the disclosure, which comprises a flash memory 102 and a control unit 104. The control unit 104 operates the flash memory 102 in accordance with the commands issued from a host 106.

The storage space of the flash memory 102 is allocated to provide ISP (in-system-program) blocks 110, spare blocks 112, a run-time write block BLK_S for sequential data (also called a sequential-data run-time write block), a run-time write block BLK_R for random data (also called a random-data run-time write block), a data pool 114 for sequential data and a data pool 116 for random data. The ISP blocks 110 store in-system programs (ISPs). The sequential-data run-time write block BLK_S for sequential data and the random-data run-time write block BLK_R are allocated from the spare blocks 112 for reception of write data. When the collection of write data on the sequential-data run-time write block BLK_S is finished, the sequential-data run-time write block BLK_S is pushed into the data pool 114. When the collection of write data on the random-data run-time write block BLK_R is finished, the random-data run-time write block BLK_R is pushed into the data pool 116.

The control unit 104 includes a microcontroller 120, a random access memory 122 (e.g. an SRAM), and a read-only memory 124. The read-only memory 124 stores read-only codes (e.g. ROM code). The microcontroller 120 operates by executing the ROM code stored in the read-only memory 124 or/and by executing the ISPs stored in the ISP blocks 110 of the flash memory 102.

The microcontroller 120 is configured to build an ending logical address mapping table EndAddrTAB in the random access memory 122 to record the ending logical address EndAddr1, EndAddr2 . . . EndAddrj . . . EndAddrN of the old write commands Ocmd1, Ocmd2 . . . Ocmdj . . . OcmdN, respectively. The old write commands Ocmd1, Ocmd2 . . . Ocmdj . . . OcmdN are issued from the host 106. When receiving a current write command Ccmd issued from the host 106, the microcontroller 120 is further configured to compare the starting logical address StartAddr of the current write command Ccmd and the information recorded in the ending logical address table EndAddrTAB. The microcontroller 120 is configured to determine whether any of the old write commands Ocmd1, Ocmd2 . . . Ocmdj . . . OcmdN is a former string write command with respect to the current write command Ccmd. The former string write command and the current write command Ccmd combined together form sequential data writing (e.g., writing data sections with consecutive logical addresses with respect to each other). In this manner, the sequential write operation interrupted due to the operations of the operating system at the host 106 side is successfully recognized.

A sequential write operation may be interrupted due to a task scheduling algorithm (e.g. for disk cache or page cache), a multi-processing structure or a journal file system at the host 106 side. In accordance with an exemplary embodiment of the disclosure, the interrupted sequential data writing is easily recognized. When it is recognized by the microcontroller 120 that a starting logical address StartAddr of the current write command Ccmd is sequential to an ending logical address EndAddrj recorded in the ending logical address table EndAddrTAB for an old write command Ocmdj, the microcontroller 120 is configured to overwrite the ending logical address EndAddr of the current write command Ccmd onto the column recording the ending logical address EndAddj of the former string write command Ocmdj in the ending logical address table EndAddrTAB.

In an exemplary embodiment, when it is determined that none of the old write commands Ocmd1, Ocmd2 . . . Ocmdj . . . OcmdN is the former string write command with respect to the current write command Ccmd, the microcontroller 120 is configured to determine whether the write length of the current write command Ccmd is longer than a threshold length. When the write length of the current write command Ccmd is longer than the threshold length, the write data issued by the current write command Ccmd is regarded as sequential data.

In an exemplary embodiment, when one of the old write commands Ocmd1, Ocmd2 . . . Omdj . . . OcmdN is determined as the former string write command with respect to the current write command Ccmd or when the current write command Ccmd requests to write data longer than the threshold length, the microcontroller 120 is configured to write the write data of the current write command Ccmd into the sequential-data run-time write block BLK_S. When none of the old write commands Ocmd1, Ocmd2. . .Ocmdj. . .OcmdN is determined as the former string write command with respect to the current write command Ccmd and the current write command Ccmd requests to write data not longer than the threshold length, the microcontroller 120 is configured to write the write data of the current write command Ccmd into the random-data run-time write block BLK_R. In this manner, the sequential data that was divided into sections may be completely collected in the flash memory 102. The management of the storage space of flash memory is improved by using separate blocks to store random data and sequential data. For example, the efficiency of garbage collection between the blocks may be improved.

In an exemplary embodiment, when none of the old write commands Ocmd1, Ocmd2 . . . Ocmdj . . . OcmdN is determined as the former string write command with respect to the current write command Ccmd and there is a spare space in the ending logical address table EndAddrTAB, the microcontroller 120 is configured to use the spare space of the ending logical address table EndAddrTAB to record the ending logical address EndAddr of the current write command Ccmd.

In an exemplary embodiment, when none of the old write commands Ocmd1, Ocmd2 . . . Ocmdj . . . OcmdN is determined as the former string write command with respect to the current write command Ccmd and there is no spare space in the ending logical address table EndAddrTAB, the microcontroller 120 is configured to determine whether any column in the ending logical address table EndAddrTAB is qualified to be cleaned for a spare space for the ending logical address EndAddr of the current write command Ccmd. In an exemplary embodiment, the column that has not been changed over a threshold time is qualified to be cleaned.

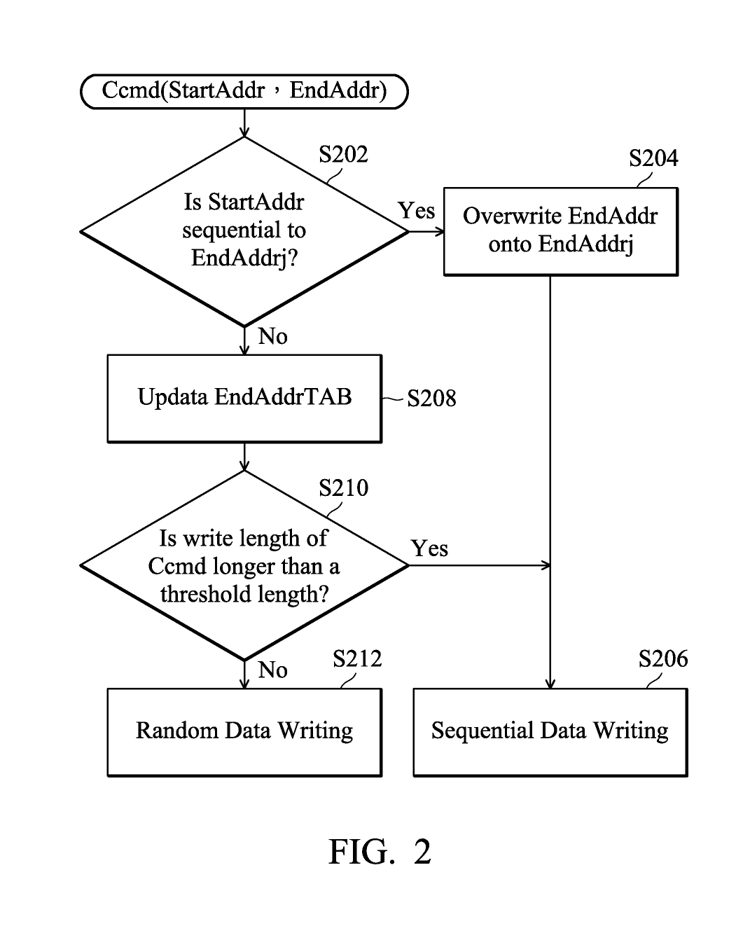

FIG. 2 is a flowchart depicting a write operation of a flash memory in accordance with an exemplary embodiment of the disclosure. For a current write command Ccmd with a starting logical address StartAddr and an ending logical address EndAddr, step S202 checks the ending logical address table EndAddrTAB based on the starting logical address StartAddr to determine whether any of the old write commands Ocmd1, Ocmd2 . . . Ocmdj . . . OcmdN is a former string write command with respect to the current wrte command Ccmd. The former string write command and the current write command Ccmd combined together form sequential data writing. When it is determined that the starting logical address StartAddr of the current write command Ccmd is sequential to an ending logical address EndAddrj of an old command Oldj stored in the ending logical address table EndAddrTAB, steps 204 is performed to overwrite the ending logical address EndAddr of the current write command Ccmd onto the column recording the ending logical address EndAddrj of the old write command Ocmdj. Then, step S206 is performed for sequential data writing, e.g. writing the write data issued in the write command Ccmd into the sequential-data run-time write block BLK_S.

When it is determined in step S202 that the starting logical address StartAddr of the current write command Ccmd is not sequential to any ending logical address recorded in the ending logical address table EndAddrTAB, step S208 is performed to update the ending logical address table EndAddrTAB. For example, the ending logical address EndAddr of the current write command Ccmd may be written into the spare space of the ending logical address table EndAddrTAB. In some exemplary embodiments, when there is no spare space in the ending logical address table EndAddrTAB for the ending logical address EndAddr of the current write command Ccmd, it is checked whether any column of the ending logical address table EndAddrTAB is qualified to be cleaned for a spare space for the ending logical address EndAddr of the current write command Ccmd. In step S210, it is determined whether the write length of the current write command Ccmd is longer than a threshold length. When the write length is longer than the threshold length, step S206 designed for sequential data writing is performed. When the write length of the current write command Ccmd is not longer than the threshold length, step S212 is performed for random data writing, e.g. writing the write data issued in the write command Ccmd into the random-data run-time write block BLK_S.

The invention further involves flash memory control methods, which are not limited to any specific controller architecture. Furthermore, any technique using the aforementioned concept to control a flash memory is within the scope of the invention.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory; and
a control unit, comprising a microcontroller and a random access memory and coupled between a host and the flash memory,
wherein:
the microcontroller is configured to build an ending logical address table in the random access memory to record ending logical addresses of a plurality of old write commands issued from the host;
the microcontroller is configured to compare a starting logical address of a current write command and information recorded in the ending logical address table to determine whether any of the old write commands is a former string write command with respect to the current write command that the former string write command and the current write command combined together form sequential data writing; and
the microcontroller is configured to overwrite an ending logical address of the current write command onto a column in the ending logical address table recording the ending logical address of the former string write command.

2. The data storage device as claimed in claim 1, wherein:
when determining that none of the old write commands is the former string write command, the microcontroller is configured to determine whether a write length of the current write command is longer than a threshold length and regard the current write command longer than the threshold length as a request for sequential data writing.

3. The data storage device as claimed in claim 2, wherein:
the flash memory has a storage space that is divided into a plurality of physical blocks;
when determining that one of the old write commands is the former string write command with respect to the current write command or determining that the write length of the current write command is longer than the threshold length, the microcontroller is configured to use a sequential-data run-time write block to receive write data of the current write command, wherein the sequential-data run-time write block is allocated from the plurality of physical blocks of the flash memory; and
when determining that none of the old write commands is the former string write command with respect to the current write command and determining that the write length of the current write command is not longer than the threshold length, the microcontroller is configured to use a random-data run-time write block to receive write data of the current write command, wherein the random-data run-time write block is allocated from the plurality of physical blocks of the flash memory.

4. The data storage device as claimed in claim 1, wherein:
when determining that none of the old write commands is the former string write command with respect to the current write command and determining that there is a spare space in the ending logical address table, the microcontroller is further configured to use the spare space to record the ending logical address of the current write command.

5. The data storage device as claimed in claim 1, wherein:
when determining that none of the old write commands is the former string write command with respect to the current write command and there is no spare space in the ending logical address table, the microcontroller is further configured to determine whether any column in the ending logical address table is qualified to be cleaned for a spare space for the ending logical address of the current write command.

6. A flash memory control method, comprising:
building an ending logical address table in a random access memory to record ending logical addresses of a plurality of old write commands issued from a host;
comparing a starting logical address of a current write command and information recorded in the ending logical address table to determine whether any of the old write commands is a former string write command with respect to the current write command that the former string write command and the current write command combined together form sequential data writing; and
overwriting an ending logical address of the current write command onto a column in the ending logical address table recording the ending logical address of the former string write command.

7. The flash memory control method as claimed in claim 6, wherein:
when none of the old write commands is determined as the former string write command, it is further determined whether a write length of the current write command is longer than a threshold length and the current write command longer than the threshold length is regarded as a request for sequential data writing.

8. The flash memory control method as claimed in claim 7, wherein:
when one of the old write commands is determined as the former string write command with respect to the current write command or the write length of the current write command is longer than the threshold length, write data of the current write command is written into a sequential-data run-time write block allocated from a plurality of physical blocks of the flash memory; and
when none of the old write commands is determined as the former string write command with respect to the current write command and the write length of the current write command is not longer than the threshold length, write data of the current write command is written into a random-data run-time write block allocated from the plurality of physical blocks of the flash memory.

9. The flash memory control method as claimed in claim 6, wherein:
when none of the old write commands is determined as the former string write command with respect to the current write command and there is a spare space in the ending logical address table, the ending logical address of the current write command is written into the spare space.

10. The flash memory control method as claimed in claim 6, wherein:
when none of the old write commands is determined as the former string write command with respect to the current write command and there is no spare space in the ending logical address table, it is further determined whether any column of the ending logical address table is qualified to be cleaned for a spare space for the ending logical address of the current write command.
